(19) United States
(12) Patent Application Publication
(10) Pub. No.: US 2017/0261166 A1
(43) Pub. Date: Sep. 14, 2017

(54) LIGHTING APPARATUS FOR VEHICLE

(71) Applicants: HYUNDAI MOTOR COMPANY, SEOUL (KR); HYUNDAI MOBIS CO., LTD., SEOUL (KR)

(72) Inventors: BYOUNG SUK AHN, SUWON-SI (KR); JIK SOO SHIN, INCHEON (KR); KI HONG LEE, SEOUL (KR); JIN HO NA, YONGIN-SI (KR); KEON SOO JIN, ULSAN (KR); NAM HYEOK KWAK, YONGIN-SI (KR); GUN DUK KIM, YONGIN-SI (KR)

(73) Assignees: HYUNDAI MOTOR COMPANY, SEOUL (KR); HYUNDAI MOBIS CO., LTD., SEOUL (KR)

(21) Appl. No.: 15/203,400

(22) Filed: Jul. 6, 2016

(30) Foreign Application Priority Data
Mar. 9, 2016 (KR) 10-2016-0028114

(51) Int. Cl. F21S 8/10; F21V 9/16; F21V 9/14

(52) U.S. Cl. CPC F21S 48/114; F21V 9/14; F21S 48/1317; F21S 48/1225; F21V 9/16; F21Y 2115/30

(57) ABSTRACT

A lighting apparatus for a vehicle may include a light source for emitting polarized beams in different directions, a filter for receiving the polarized beams emitted from the light source, reflecting a first of the polarized beams, and transmitting a second of the polarized beams, a reflective condenser for receiving the polarized beams from the filter, and focusing the received polarized beams on a focal point, and an emitter disposed on a path, along which the polarized beams emerging from the reflective condenser travel to be focused, to emit the received polarized beams as light of a predetermined color.

### CROSS-REFERENCE TO RELATED APPLICATION

The present application claims priority to Korean Patent Application No. 10-2016-0028114, filed Mar. 9, 2016, the entire contents of which is incorporated herein for all purposes by this reference.

### BACKGROUND OF THE INVENTION

Field of the Invention

The present invention relates to a lighting apparatus for a vehicle configured to focus beams emitted from a plurality of light sources on an emitter to emit light.

Description of Related Art

Generally, headlamps emit light in a travel direction of a vehicle during travel of the vehicle, to illuminate a road in front of the vehicle, and, as such, the headlamps provide visibility to the driver during nighttime driving. As forward visibility is secured during nighttime driving, using a headlamp, the driver may check obstacles or other vehicles on the road and, as such, safe driving may be achieved.

A high brightness light source is necessary to improve long-range illumination performance at night. A conventional lighting apparatus applied to such lamps includes an excitation light source, a fluorescent substance, and a reflective surface. In this case, the number of reflective surfaces is determined in accordance with the number of light sources. In this regard, there is disadvantage in terms of layout. As a result, the degree of freedom in design is lowered.

Furthermore, in the case of a conventional optical system, the number of excitation light sources is increased in accordance with the number of fluorescent substances. Thus, manufacturing costs are increased and the size of the optical system is enlarged.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a lighting apparatus for a vehicle configured to focus beams emitted from a plurality of light sources on a fluorescent substance, thereby reducing the size of an optical system, increasing the degree of freedom in design, and reducing manufacturing costs.

According to various aspects of the present invention, a lighting apparatus for a vehicle may include a light source for emitting polarized beams in different directions, a filter for receiving the polarized beams emitted from the light source, reflecting a first of the polarized beams, and transmitting a second of the polarized beams, a reflective condenser for receiving the polarized beams from the filter, and focusing the received polarized beams on a focal point, and an emitter disposed on a path, along which the polarized beams emerging from the reflective condenser travel to be focused, to emit the received polarized beams as light of a predetermined color.

The light source may include a first light source and a second light source, the first light source may emit a polarized beam in at least one of a longitudinal direction and a lateral direction, and the second light source may emit a polarized beam in at least one of a lateral direction and a longitudinal direction different from the direction of the polarized beams emitted from the first light source.

The first light source may be configured to emit the longitudinal polarized beam, and the second light source may be configured to emit the lateral polarized beam.

The first and second light sources may be disposed to have an angle difference of 90° between each other to provide a phase difference of 90° between the polarized beams of the first and second light sources.

The filter may include a mirror spaced apart at a predetermined distance from the light source, and configured to reflect the polarized beam emitted by the first light source, and a polarization filter configured to reflect the longitudinal polarized beam emitted by the first light source and transmit the lateral polarized beam emitted by the second light source.

The mirror receiving the polarized beam emitted by the first light source may be disposed over the polarization filter receiving the polarized beam emitted by the second light source, the mirror may reflect the longitudinal polarized beam emitted by the first light source downwards, and the polarization filter may reflect the longitudinal polarized beam reflected by the mirror to proceed straight forward, and transmit the lateral polarized beam emitted by the second light to proceed straight forward.

The reflective condenser may be forward spaced apart at a predetermined distance from the polarization filter, and the reflective condenser may reflect the longitudinal and lateral polarized beams reflected and transmitted through the polarization filter so the reflected beams form the focal point on a vertical line extending upwards from the reflective condenser.

The emitter may be disposed adjacent to the focal point formed by the reflective condenser.

The lighting apparatus may further include an optical lens to guide the polarized beams emitted from the light source to proceed straight in parallel.

The light emitted from the emitter may be incident upon a reflector or a lens to illuminate a front or rear of the vehicle.

The lighting apparatus may further include a housing having an inner space, in which the light source may be disposed at a supporter which is disposed at a rear side of the inner space of the housing, the filter and the reflective condenser may be disposed in line forward of and spaced apart from the light source, respectively, and the emitter may be disposed at an upper end of the housing and over the reflective condenser.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a lighting apparatus for a vehicle according to various embodiments of the present invention.

FIG. 2 is a view illustrating the lighting apparatus according to various embodiments of the present invention.

FIG. 3 is a view illustrating the lighting apparatus according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

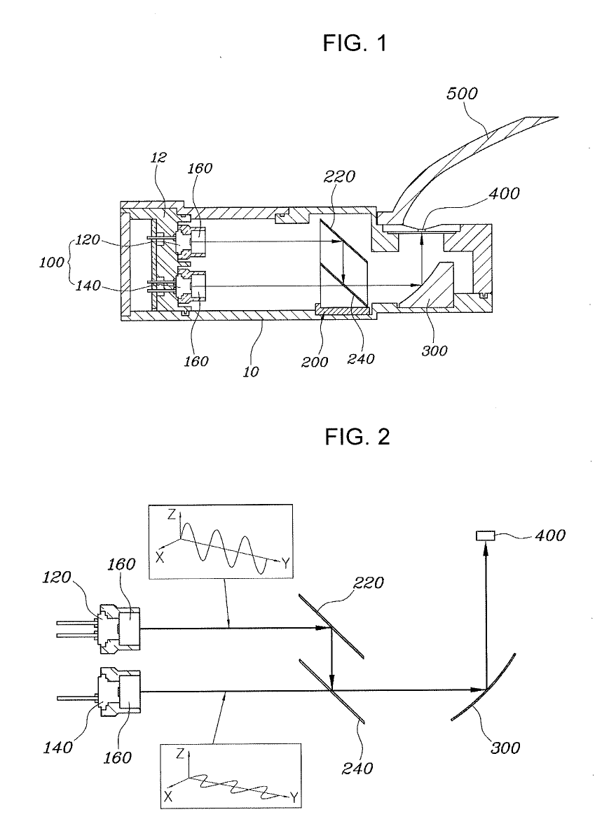

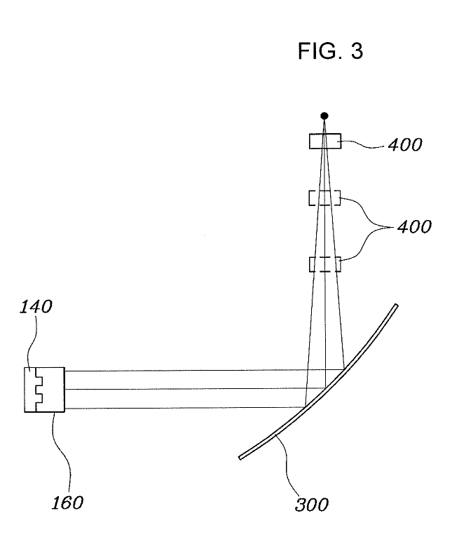

FIG. 1 is a view illustrating a lighting apparatus for a vehicle according to various embodiments of the present invention, and FIGS. 2 and 3 are views illustrating the lighting apparatus according to various embodiments of the present invention.

As shown in FIG. 1, the lighting apparatus for the vehicle according to various embodiments of the present invention includes a light source 100 for emitting polarized beams in different directions, a filter 200 arranged to receive the polarized beams emitted from the light source 100 and configured to reflect one group of the received polarized beams while transmitting the other group of the received polarized beams, a reflective condenser 300 for receiving the polarized beams from the filter 200, and reflecting the received polarized beams to be focused on a focal point, and an emitter 400 disposed in a beam path, along which the polarized beams emerging from the reflective condenser 300 travel to be focused, to emit the received polarized beams as light of a predetermined color.

In various embodiments of the present invention, the light source 100 may include a laser diode. In this case, the laser diode may be configured to generate a blue beam. When the laser diode is applied to the light source 100, as described above, it is possible to easily implement use of a plurality of light sources forming the light source 100. Particularly, in this case, the plurality of light sources may be configured to emit polarized beams in different directions, respectively. This is because the laser diode forming the light source 100 has specific polarization and, as such, wavelengths of laser beams may be set to be different from one another through installation of laser diodes at different angles.

When the light source 100 includes a plurality of light sources, as described above, the filter 200 may reflect one group of the polarized beams emitted from the light source 100 and transmit the other group of the emitted polarized beams. To this end, the filter 200 may include a polarization filter 240. In this case, the polarization filter 240 may reflect one group of polarized beams emitted from one part of the light source 100 and transmit the other group of polarized beams emitted from the other part of the light source 100. As such, the polarized beams incident upon the filter 200 may be finally output through one emitter 400. The filter 200 will be described in detail below.

The polarized beams emerging from the filter 200 are incident upon the reflective condenser 300. The reflective condenser 300 reflects the incident polarized beams to be focused on a specific point as a focal point. That is, when the polarized beams emitted from the light source 100 are incident upon the reflective condenser 300 as collimated beams, the reflective condenser 300 reflects the incident polarized beams to be focused on a specific point. As such, the position of the emitter 400 may be determined based on a position where the focal point is formed. In the other words, as the position of the emitter 400 is determined based on the focal point formed by the reflective condenser 300, the cross sectional area of laser beams emitted from the light source 100 may be selectively designed.

Meanwhile, the emitter 400 includes a fluorescent substance. In this case, the fluorescent substance reacts with laser beams emitted from the light source 100 to output light of a predetermined color. For example, when the light source 100 is configured to emit blue laser beams and the emitter 400 includes a fluorescent substance emitting a yellow color, the blue laser beams react with the yellow fluorescent substance, and, as such, a laser beam visually recognizable as white light may be emitted.

As described above, according to various embodiments of the present invention, the polarized beams emitted from the light source 100 including a plurality of light sources are output through the single emitter 400 after sequentially moving through the filter 200 and the reflective condenser 300. Thus, the entire layout of the lighting apparatus may be reduced.

In various embodiments, as illustrated in FIGS. 1 and 2, the light source 100 includes a first light source 120 and a second light source 140. The first light source 120 emits polarized beams in a longitudinal direction or a lateral direction. The second light source 140 emits polarized beams in a lateral direction or a longitudinal direction, which is different from the direction of the polarized beams emitted from the first light source 120. That is, the first and second light sources 120 and 140 are configured to emit polarized beams in different directions, respectively. When the first light source 120 emits longitudinal polarized beams, the second light source 140 may emit lateral polarized beams. On the other hand, when the first light source 120 emits lateral polarized beams, the second light source 140 may emit longitudinal polarized beams. An arrangement of a mirror 220 and the polarization filter 240 in the filter 200, which will be described below, may be changed in accordance with the directions of the polarized beams emitted from the first and second light sources 120 and 140.

The following description will be given in conjunction with various embodiments of the present invention, in which the first light source 120 emits longitudinal polarized beams and the second light source 140 emits lateral polarized beams.

The light source 100 may include two light sources, namely, the first and second light sources 120 and 140. Each of the polarized beams of the first and second light sources 120 and 140 may have specific polarization. In other words, the first and second light sources 120 and 140 may be configured to have identical specifications, while having different installation angles, respectively. As such, directions of the polarized beams may be different from each other.

Likewise, the first and second light sources 120 and 140 may be installed to have an angle difference of 90° therebetween. Thus, the polarized beams of the first and second light sources 120 and 140 may have a phase difference of 90°. When the first and second light sources 120 and 140 have the phase difference of 90° therebetween, as described above, it may be possible to easily design the first and second light sources 120 and 140, which should have different installation angles. Additionally, it may be possible to easily configure the polarization filter 240 of the filter 200, such that the polarization filter 240 transmits one group of polarized beams of one direction while reflecting the other group of polarized beams of the other direction. Of course, the angle between the directions of the polarized beams emitted from the first and second light sources 120 and 140, to be reflected or transmitted by the polarization filter 240, may be set to have various angles rather than 90°.

Furthermore, as the first and second light sources 120 and 140 are configured to emit the polarized beams in different directions, respectively, as described above, the first light source 120 may emit longitudinal polarized beams and the second source 140 may emit lateral polarized beams. As such, in this case, although the first and second light sources 120 and 140 have the same installation position, the directions of the polarized beams of the first and second light sources 120 and 140 may be different from each other.

Meanwhile, the mirror 220, which is included in the filter 200, may be spaced apart a predetermined distance from the light source 100. The mirror 220 may reflect the longitudinal polarized beams emitted from the first light source 120. The polarization filter 240, which is included in the filter 200, may reflect the longitudinal polarized beams reflected from the mirror 220 and transmit the lateral polarized beams emitted from the second light source 140.

Here, the mirror 220 may change the beam path of the polarized beams emitted from the first light source 120. In various embodiments, a prism may be employed in place of the mirror 220.

The polarization filter 240 of the filter 200 classifies incident laser beams into a vertically polarized wave and a horizontally polarized wave in order to reflect or transmit the incident laser beams. The polarization filter 240 may include a polyvinyl alcohol (PVA) film (a polarizing element) dyed with a dichroic material, and tri-acetate cellulose (TAC) films bonded to both sides of the polarizing element, to function as a protector. In this case, the polarization filter 240 may have a three-layer structure of TAC-PVA-TAC. Here, a surface coating process may be further performed on surfaces of the TAC films to provide required characteristics, for example, scattering, hardness enhancement, and reflection characteristics.

In detail, in the filter 200, the mirror 220 receiving the polarized beams of the first light source 120 may be disposed over the polarization filter 240 receiving the polarized beams of the second light source 140. The mirror 220 may be configured to reflect the polarized beams emitted from the first light source 120 to proceed downwards. The polarization filter 240 may be configured to reflect the longitudinal polarized beams reflected from the mirror 220 to proceed straight forward while transmitting the polarized beams emitted from the second light source 140 to proceed forward.

As shown in FIG. 1, the first light source 120 may be disposed over the second light source 140. The mirror 220 of the filter 200 may be disposed in line with and spaced apart from the first light source 120 in a horizontal direction. The polarization filter 240 may be disposed in line with and spaced apart from the second light source 140 in the horizontal direction while being disposed below the mirror 220. In particular, the mirror 220 may be installed to be tilted at a predetermined angle so that the polarized beams emitted from the first light source 120 are vertically downwards reflected. In addition, the polarization filter 240 may be installed to be tilted at a predetermined angle so that the polarized beams emitted from the second light source 140 are horizontally transmitted forward. Furthermore, the reflective condenser 300 may be forwards spaced apart from the polarization filter 240. Thus, the polarized beams reflected and transmitted through the mirror 220 and the polarization filter 240 may be incident upon the reflective condenser 300.

Here, the first light source 120 emits longitudinal polarized beams. The second light source 140 is configured to emit lateral polarized beams. The polarization filter 240 is configured to reflect the longitudinal polarized beams and to transmit the lateral polarized beams. Accordingly, after the beam path of the longitudinal polarized beams emitted from the first light source 120 is changed by the mirror 220 toward the polarization filter 240, the longitudinal polarized beams are reflected by the polarization filter 240 to be incident upon the reflective condenser 300. Whereas, the lateral polarized beams emitted from the second light source 140 are transmitted through the polarization filter 240 to directly proceed to the reflective condenser 300.

Accordingly, the polarized beams emitted from the first and second light source 120 and 140 proceed to the single reflective condenser 300 via the filter 200 including the mirror 220 and the polarization filter 240, and then are incident upon the single emitter 400. Thus, the size of an optical system may be reduced, and as such, a desired degree of freedom in design may be secured.

Meanwhile, the reflective condenser 300 may be forward spaced apart a predetermined distance from the polarization filter 240. The reflective condenser 300 may be configured to reflect the longitudinal and lateral polarized beams reflected and transmitted through the polarization filter 240 upwards such that the reflected beams form a focal point on a vertical line extending upwards from the reflective condenser 300.

Accordingly, the light source 100 may further include optical lenses 160. Each optical lens 160 causes the polarized beams emitted from the light source 100 to proceed straight in parallel, so that luminous fluxes of the polarized beams may be adjusted to be collimated. For this, a collimator may be applied to each optical lens in order to form collimated beams.

Thus, as the polarized beams emitted from the light source 100 are adjusted through the condensing lenses 160 to be collimated, a focal point may be formed at a specific point. In addition, as the polarized beams may be reflected by the reflective condenser 300 to be focused on the focal point, the size of polarized beams may be determined in accordance with a given design.

The focal point formed by the reflective condenser 300 will be described in conjunction with an example. In various embodiments of the present invention, the emitter 400 may be disposed adjacent to the focal point formed by the reflective condenser 300. As shown FIG. 3, when the polarized beams emitted from the second light source 140 are reflected vertically upwards by the reflective condenser 300, the polarized beams are focused on one focal point. Here, when the emitter 400 is provided at a position, which is the focal point formed by the reflective condenser 300, the size of polarized beams incident upon the emitter 400 may be reduced. Thus, laser beams emitted from the light source 100 may be output to be certainly visually recognizable through the emitter 400. Furthermore, the cross-sectional area of the polarized beams may be adjusted in accordance with the position of the emitter 400 based on the focal point, on which the polarized beams emitted from the light source 100 are focused after being reflected by the reflective condenser 300 via the mirror 220 and polarization filter 240. As shown in FIG. 3, as the emitter 400 approaches the reflective condenser 300 between the reflective condenser 300 and the focal point, on which the polarized beams are focused through the reflective condenser 300, the size of polarized beams may be increased. Additionally, the entire layout may be decreased, and as such, the size of polarized beams may be determined according to the lighting design for the vehicle.

Meanwhile, the polarized beams output through the emitter 400 may illuminate a front or rear of the vehicle via a reflector 500 or a lens. Here, the reflector 500 may include a reflective plate. When the polarized beams emitted from the first and second light source 120 and 140 are output through the emitter 400 after moving through the filter 200 and being reflected by the reflective condenser 300, the polarized beams output from the emitter 400 are incident upon the reflector 500 to illuminate the front and rear of the vehicle. Alternatively, the polarized beams output through the emitter 400 may be incident upon the lens to illuminate the front and rear of the vehicle.

Namely, the reflector 500 or the lens is applied in order to illuminate a point where visibility for the driver should be secured.

Meanwhile, as shown in FIG. 1, a housing 10 having an inner space may be further provided. A supporter 12, where the light source 100 is installed, may be disposed at a rear side of the inner space. Further, the filter 200 and the reflective condenser 300 may be disposed in line forward of and spaced apart from the light source 100, respectively. The emitter 400 may be provided at an upper end of the housing 10 and above the reflective condenser 300.

As the supporter 12 may be provided at the rear side of the inner space of the housing 10, the first and second light sources 120 and 140 may be installed at upper and lower portions of the supporter 12, respectively. In addition, the filter 200 is disposed in line forward of and spaced apart from the light source 100. Thus, the polarized beams emitted by the light source 100 are incident upon the filter 200. When the longitudinal and lateral polarized beams emitted from the light source 100 are incident upon the reflective condenser 300 after being reflected by the filter 200, the beam path of the polarized beams is changed through the reflective condenser 300 toward the emitter 400, which is disposed at the upper end of the housing 10. As such, the polarized beams are emitted through the emitter 400 as light. Furthermore, the emitted light illuminates an outside through the reflector 500 for the vehicle lighting.

As is apparent from the above description, according to the lighting apparatus for the vehicle of the various embodiments, which has the above-described configuration, the polarized beams emitted from a plurality of light sources 120 and 140 are incident upon the single emitter 400, thereby reducing a size of the optical system and increasing the degree of the freedom in design. In addition, the size of layout may be reduced, thereby decreasing manufacturing costs and weight of the vehicle.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A lighting apparatus for a vehicle comprising:
a light source for emitting polarized beams in different directions;
a filter for receiving the polarized beams emitted from the light source, reflecting a first beam of the polarized beams, and transmitting a second beam of the polarized beams;
a reflective condenser for receiving the first and second beams of the polarized beams from the filter, and focusing the received polarized beams on a focal point thereof; and
an emitter disposed on a path, along which the polarized beams emerging from the reflective condenser travel to be focused, to emit the received polarized beams as light of a predetermined color.

2. The lighting apparatus according to claim 1, wherein
the light source comprises a first light source and a second light source;
the first light source emits a polarized beam in at least one of a longitudinal direction and a lateral direction; and
the second light source emits a polarized beam in at least one of a lateral direction and a longitudinal direction different from the direction of the polarized beams emitted from the first light source.

3. The lighting apparatus according to claim 2, wherein the first light source is configured to emit the longitudinal polarized beam, and the second light source is configured to emit the lateral polarized beam.

4. The lighting apparatus according to claim 3, wherein the first and second light sources are disposed to have an angle difference of 90° between each other to provide a phase difference of 90° between the polarized beams of the first and second light sources.

5. The lighting apparatus according to claim 3, wherein the filter comprises:
a mirror spaced apart at a predetermined distance from the light source, and configured to reflect the polarized beam emitted by the first light source; and
a polarization filter spaced from the mirror and configured to reflect the longitudinal polarized beam emitted by the first light source and transmit the lateral polarized beam emitted by the second light source.

6. The lighting apparatus according to claim 5, wherein the mirror receiving the polarized beam emitted by the first light source is disposed over the polarization filter receiving the polarized beam emitted by the second light source;
the mirror reflects the longitudinal polarized beam emitted by the first light source toward the polarization filter; and
the polarization filter reflects the longitudinal polarized beam reflected by the mirror to proceed straight forward, and transmits the lateral polarized beam emitted by the second light to proceed straight forward.

7. The lighting apparatus according to claim 6, wherein the reflective condenser is forward spaced apart at a predetermined distance from the polarization filter; and
the reflective condenser reflects the longitudinal and lateral polarized beams reflected and transmitted through the polarization filter so the reflected beams form the focal point on a vertical line extending upwards from the reflective condenser.

8. The lighting apparatus according to claim 1, wherein the emitter is disposed adjacent to the focal point formed by the reflective condenser.

9. The lighting apparatus according to claim 1, further comprising an optical lens positioned in front of the light source to guide the polarized beams emitted from the light source to proceed straight in parallel to each other.

10. The lighting apparatus according to claim 1, wherein the light emitted from the emitter is incident upon a reflector or a lens to illuminate a front or rear of the vehicle.

11. The lighting apparatus according to claim 1, further comprising a housing having an inner space, wherein
the light source is disposed at a supporter disposed at a first side of the inner space of the housing;
the filter and the reflective condenser are disposed in line forward of and spaced apart from the light source, respectively; and
the emitter is disposed at an upper end of a second side of the housing and over the reflective condenser.
